(19) United States
(12) Patent Application Publication
(10) Pub. No.: US 2026/0056949 A1
(43) Pub. Date: Feb. 26, 2026

(54) MATERIALIZED VIEW CONSTRUCTION METHOD, DEVICE AND MEDIUM IN DATABASE SYSTEM

(71) Applicant: Beijing Volcano Engine Technology Co., Ltd., Beijing (CN)

(72) Inventors: Liya FAN, Beijing (CN); Dongyan Zhou, Beijing (CN); Jianhua Cao, Beijing (CN); Heng Chen, Beijing (CN); Rui Shi, Beijing (CN)

(21) Appl. No.: 19/224,311

(22) Filed: May 30, 2025

(30) Foreign Application Priority Data
Aug. 23, 2024 (CN) 202411166567.6

(51) Int. Cl. G06F 16/2453

(52) U.S. Cl. CPC G06F 16/24539

(57) ABSTRACT

A materialized view construction method, a device, and a medium in a database system are provided. The method includes: receiving a materialized view construction request for a target base table; determining whether the materialized view construction request satisfies a preset construction condition after determining that the target base table belongs to a target type; and constructing a materialized view of the target base table based on a target query statement when determining that the materialized view construction request is executable.

### CROSS-REFERENCE TO RELATED APPLICATION

This application claims priority to Chinese Patent Application No. 202411166567.6, filed on Aug. 23, 2024, the entire disclosure of which is incorporated herein by reference as part of the present disclosure.

### TECHNICAL FIELD

The present disclosure relates to the field of data processing, and in particular, to a materialized view construction method, a device and a medium in a database system.

### BACKGROUND

A materialized view is a special view type in a database. The materialized view pre-calculates a query result and stores the result in the materialized view. When the data of a base table changes, the materialized view also needs to be updated to determine the accuracy of the data. In the query process, the database system performs query optimization according to the content stored in the materialized view, so as to improve the query efficiency.

However, for some base tables, when the data is updated, the data of the base tables may be inconsistent with the data in the materialized view. Therefore, how to create a materialized view of a base table in the database becomes a technical problem to be solved.

### SUMMARY

Embodiments of the present disclosure provide a materialized view construction method in a database system, comprising: receiving a materialized view construction request for a target base table, wherein the materialized view construction request carries a target query statement for constructing a materialized view of the target base table; determining whether the materialized view construction request satisfies a preset construction condition after determining that the target base table belongs to a target type, wherein the preset construction condition is used to determine executability of the materialized view construction request according to whether a query statement of the materialized view comprises an aggregate operation and/or a sub-statement of the query statement of the materialized view references a target base table, the target type comprises a first type or a second type, the first type is used to identify a table with a unique constraint condition, and the second type is used to identify a table storing aggregate data; and constructing the materialized view of the target base table based on the target query statement in response to determining that the materialized view construction request is executable.

In at least one embodiment, the determining whether the materialized view construction request satisfies the preset construction condition after determining that the target base table belongs to the target type comprises: determining whether the target query statement comprises an aggregate operation after determining that the target base table belongs to the first type; and determining whether the target query statement satisfies a first condition match item in the preset construction condition after determining that the target query statement does not comprise the aggregate operation, wherein the first condition match item is used to determine the executability of the materialized view construction request according to a type of the sub-statement of the query statement of the materialized view and whether the sub-statement references a column of the target base table.

In at least one embodiment, the determining whether the materialized view construction request satisfies the preset construction condition after determining that the target base table belongs to the target type comprises: determining whether the target query statement comprises an aggregate operation after determining that the target base table belongs to the second type; determining whether the target query statement satisfies a second condition match item in the preset construction condition after determining that the target query statement comprises the aggregate operation, wherein the second condition match item is used to determine the executability of the materialized view construction request according to at least two selected from the group consisting of a type of the sub-statement of the query statement of the materialized view, whether the sub-statement references a column of the target base table, and whether an aggregate operation satisfies a rule; and determining whether the target query statement satisfies a third condition match item in the preset construction condition after determining that the target query statement does not comprise the aggregate operation, wherein the third condition match item is used to determine the executability of the materialized view construction request according to the type of the sub-statement of the query statement of the materialized view and whether the sub-statement referencing the column of the target base table.

In at least one embodiment, before the determining whether the target query statement satisfies the first condition match item in the preset construction condition, the determining whether the materialized view construction request satisfies the preset construction condition after determining that the target base table belongs to the target type further comprises: determining whether the target base table comprises a target monotonically increasing column after determining that the target query statement does not comprise the aggregate operation, wherein the target monotonically increasing column belongs to a value column of the target base table and is used to trigger an update of the target base table; and correspondingly, the determining whether the target query statement satisfies the first condition match item in the preset construction condition comprises: determining whether a query list sub-statement of the target query statement references the target monotonically increasing column after determining that the target base table comprises the target monotonically increasing column.

In at least one embodiment, the first condition match item is further used to determine the executability of the materialized view construction request according to whether a column of the query statement of the materialized view participates in calculation; the determining whether the target query statement satisfies the first condition match item in the preset construction condition after determining that the target query statement does not comprise the aggregate operation comprises: determining whether key columns of the target base table all belong to columns referenced by the query list sub-statement of the target query statement and determining whether the key columns of the target base table participate in calculation in the target query statement after determining that the target query statement does not comprise the aggregate operation; and determining whether a condition sub-statement in the target query statement references the value column of the target base table; and correspondingly, the constructing the materialized view of the target base table based on the target query statement in response to determining that the materialized view construction request is executable comprises: constructing the materialized view of the target base table based on the target query statement in response to following conditions are simultaneously satisfied, the conditions comprising: determining that the target query statement does not comprise the aggregate operation; the target base table comprising the target monotonically increasing column, or, the target base table comprising the target monotonically increasing column and the query list sub-statement of the target query statement referencing the target monotonically increasing column; the key columns of the target base table all belonging to the columns referenced by the query list sub-statement in the target query statement and the key columns of the target base table not participating in calculation in the target query statement; and the condition sub-statement in the target query statement not referencing the value column of the target base table.

In at least one embodiment, the method further comprises: determining whether the target base table comprises a target monotonically increasing column after determining that the target base table belongs to the second type, wherein the target monotonically increasing column belongs to a value column of the target base table and is used to trigger an update of the target base table.

In at least one embodiment, the determining whether the target query statement satisfies a third condition match item in the preset construction condition after determining that the target query statement does not comprise the aggregate operation comprises: determining whether a query list sub-statement in the target query statement references the target monotonically increasing column after determining that the target query statement does not comprise the aggregate operation and the target base table comprises the target monotonically increasing column.

In at least one embodiment, the third condition match item is further used to determine the executability of the materialized view construction request according to whether a column of the query statement of the materialized view participates in calculation; the determining whether the target query statement satisfies the third condition match item in the preset construction condition comprises: determining whether aggregate key columns of the materialized view in the target query statement all belong to aggregate key columns in the target base table; determining whether the condition sub-statement in the target query statement references the value column of the target base table; and determining whether the value column of the target base table participates in calculation in the target query statement; and correspondingly, the constructing the materialized view of the target base table based on the target query statement when determining that the materialized view construction request is executable comprises: constructing the materialized view of the target base table based on the target query statement when following conditions are simultaneously satisfied, the conditions comprising: the target query statement not comprising the aggregate operation; the target base table not comprising the target monotonically increasing column, or the target base table comprising the target monotonically increasing column and the query list sub-statement of the target query statement referencing the target monotonically increasing column; the aggregate key columns of the materialized view in the target query statement all belonging to the aggregate key columns in the target base table; the condition sub-statement in the target query statement not referencing the value column of the target base table; and the value column of the target base table not participating in calculation in the target query statement.

In at least one embodiment, the determining whether the target query statement satisfies a second condition match item in the preset construction condition after determining that the target query statement comprises the aggregate operation comprises: determining whether a query list sub-statement in the target query statement references the target monotonically increasing column after determining that the target query statement comprises the aggregate operation and the target base table comprises the target monotonically increasing column.

In at least one embodiment, the second condition match item is further used to determine the executability of the materialized view construction request according to whether a column parameter of the query statement of the materialized view participates in calculation; the determining whether the target query statement satisfies the second condition match item in the preset construction condition comprises: determining whether aggregate key columns of the materialized view in the target query statement all belong to aggregate key columns in the target base table; determining whether the condition sub-statement in the target query statement references the value column of the target base table; determining whether key columns referenced by the group sub-statement in the target query statement belong to key columns of the target base table; determining whether parameters of the aggregate operation in the target query statement are from the value column of the target base table and whether the value column does not participate in calculation in the parameters of the aggregate operation; determining whether the aggregate operation in the target query statement satisfies a target calculation rule, wherein the target calculation rule comprises a commutative law and an associative law; and determining whether the aggregate operation in the target query statement is consistent with an aggregate operation of a column corresponding to the aggregate operation in the target base table.

In at least one embodiment, the method further comprises: modifying the target query statement based on the preset construction condition to enable the modified target query statement to satisfy the preset construction condition in response to determining that the materialized view construction request is not executable; displaying the modified target query statement; and constructing the materialized view of the target base table based on the modified target query statement in response to a materialized view construction request triggered for the modified target query statement.

In at least one embodiment, before the modifying the target query statement based on the preset construction condition to enable the modified target query statement to satisfy the preset construction condition, the method further comprises: determining a condition match item that is not satisfied by the target query statement in the preset construction condition and determining whether the target query statement satisfies a preset modification condition based on the condition match item; and correspondingly, the modifying the target query statement based on the preset construction condition to enable the modified target query statement to satisfy the preset construction condition comprises: modifying the target query statement based on the condition match item to enable the modified target query statement to satisfy the preset construction condition in response to the target query statement satisfying the preset modification condition.

Embodiments of the present disclosure further provide a materialized view construction apparatus in a database system, comprising: a first reception module, configured to receive a materialized view construction request for a target base table, wherein the materialized view construction request carries a target query statement for constructing a materialized view of the target base table; a first determination module, configured to determine whether the materialized view construction request satisfies a preset construction condition after determining that the target base table belongs to a target type, wherein the preset construction condition is used to determine the executability of the materialized view construction request according to whether a query statement of the materialized view comprises an aggregate operation and a sub-statement of the query statement of the materialized view references a target base table, the target type comprises a first type or a second type, the first type is used to identify a table with a unique constraint condition, and the second type is used to identify a table storing aggregate data; and a first construction module, configured to construct the materialized view of the target base table based on the target query statement in response to determining that the materialized view construction request is executable.

Embodiments of the present disclosure further provide an electronic device, comprising: a processor; and a memory, configured to store instructions executable by the processor. The processor is configured to read the instructions from the memory and execute the instructions to implement the materialized view construction method according to any one above embodiment.

The present disclosure further provides a non-transitory computer-readable storage medium, storing a computer program which, when executed by a processor, causes the materialized view construction method according to any one above embodiment to be implemented.

### BRIEF DESCRIPTION OF THE DRAWINGS

The above and other features, advantages and aspects of the embodiments of the present disclosure will become more apparent when taken in conjunction with the drawings and with reference to the following specific embodiments. Throughout the drawings, the same or similar reference numerals refer to the same or similar elements. It should be understood that the drawings are schematic and that parts and elements are not necessarily drawn to scale.

FIG. 1 is a schematic flowchart of a materialized view construction method in a database system according to an embodiment of the present disclosure;

FIG. 2 is a schematic diagram of a materialized view construction process in a database system according to an embodiment of the present disclosure;

FIG. 3 is a schematic structural diagram of a materialized view construction apparatus in a database system according to an embodiment of the present disclosure; and

FIG. 4 is a schematic structural diagram of a materialized view construction device in a database system according to an embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that various steps described in the method implementations of the present disclosure may be executed in different orders and/or in parallel. Furthermore, the method implementations may include additional steps and/or omit the execution of the illustrated steps. The scope of the present disclosure is not limited in this respect.

As used herein, the term “include/comprise” and its variants are open-ended inclusions, that is, “include/comprise but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifications of “one” and “a plurality of” mentioned in the present disclosure are illustrative and not restrictive, and those skilled in the art should understand that they should be understood as “one or more”unless the context clearly indicates otherwise.

The names of messages or information exchanged between a plurality of apparatuses in the implementations of the present disclosure are only for illustrative purposes, and are not intended to limit the scope of these messages or information.

At present, users can define a query statement of a materialized view and a data storage mode through a base table according to requirements. The database system pre-calculates a query result according to a definition of the materialized view and stores the result in the materialized view. When the data of the base table changes, the materialized view also needs to be updated to determine the accuracy of the data. In the query process, the database system performs query optimization according to the content stored in the materialized view to improve the query efficiency.

However, when creating a materialized view for a base table with a table model of unique or aggregate, data inconsistency between the base table and the materialized view may occur when the data is updated.

For example, it is assumed that the table model of a base table is unique, the base table is base_tbl, and the base_tbl has three columns a, b, and c, where a and b are key columns, and c is a value column. The table base_tbl has two records (0, 0, 0) and (0, 1, 1).

If the table model of the materialized view is also unique, the definition of the materialized view is as follows:
create mv as select a, c+1 as c1 from base_tbl;
which means that a materialized view named mv is created. The data of the materialized view comes from the table base_tbl. The column a is selected from the table base_tbl as the column a of the materialized view, and c+1 in the table base_tbl is used to obtain the column c1 of the materialized view. It can be seen that column a is the key column of the materialized view, and column c1 is the value column.

According to the data of the base table and the definition of the materialized view, the materialized view should have two records (0, 1) and (0, 2). However, since the table model of the materialized view is a unique table and the column a is the key column, these two records cannot exist in the materialized view at the same time. Therefore, the data in the materialized view and the base table are inconsistent.

Therefore, for the above tables with the table model of unique or aggregate, how to create a materialized view to ensure that the data of the base table is consistent with the data of the materialized view when the data is updated is a technical problem that needs to be solved.

To this end, an embodiment of the present disclosure provides a materialized view construction method in a database system. Specifically, first, a materialized view construction request for a target base table is received, where the materialized view construction request carries a target query statement for constructing a materialized view of the target base table. Then, after determining that the target base table belongs to a target type, whether the materialized view construction request satisfies a preset construction condition is determined, where the preset construction condition is used to determine the executability of the materialized view construction request according to whether a query statement of a materialized view comprises an aggregate operation and/or a sub-statement of the query statement of the materialized view references a base table. The target type includes a first type or a second type, the first type is used to identify a table with a unique constraint condition, and the second type is used to identify a table storing aggregate data. When determining that the materialized view construction request is executable, the materialized view of the target base table is constructed based on the target query statement.

It can be seen that, in the embodiments of the present disclosure, for a base table belonging to the target type, whether the materialized view construction request for the base table satisfies the preset construction condition is determined by determining whether the query statement of the materialized view comprises an aggregate operation and the sub-statement of the query statement of the materialized view references a base table. When the preset construction condition is satisfied, the construction of the materialized view for the base table is supported, so as to reduce the probability that the data of the base table is inconsistent with the data in the materialized view when the data is updated.

Based on this, an embodiment of the present disclosure provides a materialized view construction method in a database system, which can be applied to the database system. The method will be described below with reference to specific embodiments.

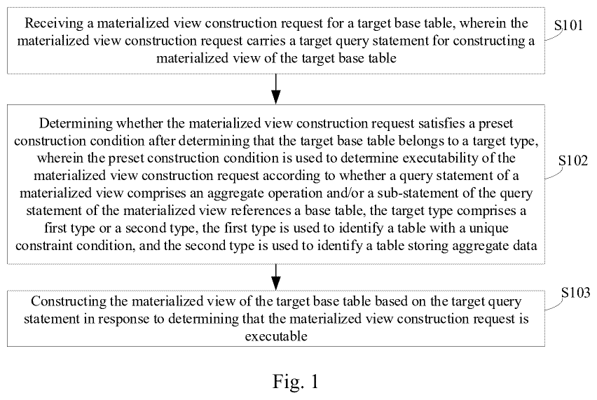

FIG. 1 is a schematic flowchart of a materialized view construction method in a database system according to an embodiment of the present disclosure. The method may be executed by a materialized view construction apparatus in the database system, and the apparatus may be implemented in software and/or hardware and may generally be integrated into an electronic device. As shown in FIG. 1, the method includes:
S101, receiving a materialized view construction request for a target base table.

The materialized view construction request carries a target query statement for constructing a materialized view of the target base table.

The target base table in the embodiments of the present disclosure is a base table of the database system, which is also referred to as a base table or a basic table. The target base table is the most basic storage unit in the database and is used to store actual data.

The materialized view construction request in the embodiments of the present disclosure is an instruction to create a materialized view, and the target query statement carried in the materialized view construction request is a creation statement of the materialized view.
S102, determining whether the materialized view construction request satisfies a preset construction condition after determining that the target base table belongs to a target type.

The preset construction condition is used to determine the executability of the materialized view construction request according to whether a query statement of the materialized view comprises an aggregate operation and/or a sub-statement of the query statement of the materialized view references the base table. The target type includes a first type or a second type, the first type is used to identify a table with a unique constraint condition, and the second type is used to identify a table storing aggregate data.

In the embodiments of the present disclosure, if the target base table belongs to the first type, it indicates that a value of one column or a combination of multiple columns in the target base table is unique. The target base table may include a table with a table model of unique. That is, if the target base table belongs to the first type, the table model of the target base table is a unique model.

If the target base table belongs to the second type, it indicates that the target base table is a table with an aggregate function, that is, the table belonging to the second type has a function of aggregating data in the table. The table belonging to the second type may include a table with a table model of aggregate. That is, if the target base table belongs to the second type, the table model of the target base table is an aggregate model.

In the embodiments of the present disclosure, after determining the target type of the target base table, whether the materialized view construction request of the target base table satisfies the preset construction condition is determined.

The preset construction condition is used to determine whether the materialized view can be created for the target base table.

In an optional implementation, the preset construction condition may be used to determine the executability of the materialized view construction request according to whether the query statement of the materialized view comprises an aggregate operation, that is, to determine the executability of the materialized view construction request by judging whether the aggregate operation is included in the query statement carried in the materialized view construction request. That is, the executability of the materialized view construction request is determined by judging whether the query statement of the materialized view comprises an aggregate operation, so as to determine whether the materialized view construction request satisfies the preset construction condition.

The aggregate operation may include aggregate operations such as statistics and calculation of data. Specifically, the aggregate operation may include a statement with an aggregate function such as a group by statement. In addition, the aggregate operation may also be implemented by an aggregate function, and the aggregate function may include a count function, a sum function, etc. in the database system.

In another optional implementation, the preset construction condition may be used to determine the executability of the materialized view construction request according to whether a sub-statement of the query statement of the materialized view carried in the materialized view construction request references the base table. The query statement of the materialized view may include a query (select) sub-statement, a condition (where) sub-statement, etc. That is, the executability of the materialized view construction request is determined by judging whether each sub-statement in the query statement of the materialized view references the base table, so as to determine whether the materialized view construction request satisfies the preset construction condition. Whether each sub-statement in the query statement may references the base table include whether each sub-statement in the query statement references the content of the base table.

In yet another optional implementation, the preset construction condition may also be used to determine the executability of the materialized view construction request according to whether the query statement of the materialized view comprises the aggregate operation and whether the sub-statement of the query statement of the materialized view references the base table, so as to determine whether the materialized view construction request satisfies the preset construction condition.
S103: constructing the materialized view of the target base table based on the target query statement when determining that the materialized view construction request is executable. The materialized view has the same table model as the target base table. That is, if the target base table belongs to the first type, the materialized view of the target base table belongs to the first type. If the target base table belongs to the second type, the materialized view of the target base table belongs to the second type.

In the embodiments of the present disclosure, by determining that the materialized view construction request is executable, it is determined that the materialized view construction request of the target base table satisfies the preset construction condition, and then the materialized view of the target base table can be constructed based on the target query statement of the materialized view of the target base table carried in the materialized view construction request, so as to pre-calculate and store data.

In the materialized view construction method in the database system provided by the embodiments of the present disclosure, specifically, first, a materialized view construction request for a target base table is received, where the materialized view construction request carries a target query statement for constructing a materialized view of the target base table. Then, after determining that the target base table belongs to a target type, whether the materialized view construction request satisfies a preset construction condition is determined, where the preset construction condition is used to determine the executability of the materialized view construction request according to whether the query statement of the materialized view comprises an aggregate operation and/or a sub-statement of the query statement of the materialized view carried in the materialized view construction request references the base table. The target type includes a first type or a second type, the first type is used to identify a table with a unique constraint condition, and the second type is used to identify a table storing aggregate data. When determining that the materialized view construction request is executable, the materialized view of the target base table is constructed based on the target query statement.

It can be seen that, in the embodiments of the present disclosure, for a base table belonging to the target type, whether the materialized view construction request for the base table satisfies the preset construction condition is determined by determining whether the query statement of the materialized view comprises an aggregate operation and whether the sub-statement of the query statement of the materialized view carried in the materialized view construction request references the base table. When the preset construction condition is satisfied, the construction of the materialized view for the base table is supported, so as to reduce the probability that the data of the base table is inconsistent with the data in the materialized view when the data is updated.

In an optional implementation, when receiving the materialized view construction request for the target base table, whether the target base table belongs to the target type is judged based on the table model of the target base table. If it is determined that the target base table belongs to the first type, whether the target query statement carried in the materialized view construction request of the target base table includes an aggregate operation is judged. If it is determined that the target query statement includes the aggregate operation, it is determined that the materialized view construction request of the target base table is not executable, that is, the materialized view construction request of the target base table does not satisfy the preset construction condition, that is, the materialized view cannot be constructed for the target base table based on the target query statement.

In another optional implementation, if it is determined that the target query statement of the materialized view of the target base table does not include the aggregate operation, whether the target query statement satisfies the first condition match item in the preset construction condition is further determined. The first condition match item may be used to determine the executability of the materialized view construction request according to a type of the sub-statement of the query statement of the materialized view and whether the sub-statement references a column of the base table. The sub-statement of the query statement of the materialized view may include a query sub-statement, a condition sub-statement, etc. That is, whether the target query statement satisfies the first condition match item in the preset construction condition is determined by judging whether sub-statements such as the query list sub-statement and the condition sub-statement in the query statement of the materialized view reference a column in the base table, that is, the first condition match item includes a condition of judging whether the sub-statements such as the query list sub-statement and the condition sub-statement in the query statement of the materialized view reference the columns in the base table.

In another optional implementation, the first condition match item may also be used to determine the executability of the materialized view construction request according to whether a column of the query statement of the materialized view participates in calculation. That is, the first condition match item also includes a condition of judging whether the key columns of the target base table participate in calculation in the target query statement.

Specifically, on the basis of determining that the target query statement of the materialized view of the target base table does not include the aggregate operation, whether the key columns of the target base table all belong to the columns referenced by the query list sub-statement in the target query statement is further determined, whether the key columns of the target base table participate in calculation in the target query statement is determined, and whether the condition sub-statement in the target query statement references the value column of the target base table is determined.

Whether the key columns of the target base table all belong to the columns referenced by the query list sub-statement in the target query statement is used to determine whether the key columns of the target base table all belong to the columns of the materialized view in the target query statement of the materialized view of the target base table. The key column of the base table is is used to store a unique identifier of data. The value column of the base table is used to store an actual data value related to the key column.

In practical applications, after determining that the target query statement of the materialized view of the target base table does not include the aggregate operation, it is further necessary to first determine whether the target base table includes a target monotonically increasing column. The target monotonically increasing column belongs to the value column of the target base table and is used to trigger an update of the target base table. Then, whether the target query statement satisfies the first condition match item in the preset construction condition is determined.

In an optional implementation, after determining that the target query statement of the materialized view of the target base table does not include the aggregate operation, if it is determined that the target base table does not include the target monotonically increasing column, whether the target query statement satisfies the first condition match item in the preset construction condition may be determined.

In another optional implementation, after determining that the target query statement of the materialized view of the target base table does not include the aggregate operation, if it is determined that the target base table includes the target monotonically increasing column, whether the query list sub-statement of the target query statement references the target monotonically increasing column is determined. If it is determined that the query list sub-statement of the target query statement does not reference the target monotonically increasing column, it can be determined that the materialized view construction request for the target base table is not executable.

If it is determined that the query list sub-statement of the target query statement references the target monotonically increasing column, it can be further determined whether the target query statement satisfies the first condition match item in the preset construction condition.

The query list sub-statement of the target query statement references the target monotonically increasing column, which indicates that the monotonically increasing column included in the target base table belongs to the query list sub-statement in the query statement of the materialized view of the target base table, and may also indicate that the materialized view of the target base table includes the monotonically increasing column, and the monotonically increasing column is used to trigger an update of the materialized view.

Based on the content of the above embodiments, if it is determined that the target query statement of the target base table does not include the aggregate operation, and the target base table does not include the target monotonically increasing column, or the target base table includes the target monotonically increasing column and the query list sub-statement of the target query statement references the target monotonically increasing column, and the key columns of the target base table all belong to the columns referenced by the query list sub-statement in the target query statement and the key columns of the target base table do not participate in calculation in the target query statement, and the condition sub-statement in the target query statement does not reference the value column of the target base table, it can be determined that the materialized view construction request is executable, that is, the materialized view of the target base table can be constructed based on the target query statement.

The condition sub-statement in the target query statement does not reference the value column of the target base table, which may mean that the condition sub-statement in the target query statement can only reference the key columns of the target base table.

That is, when the target base table belongs to the first type, it can be determined that the materialized view construction request of the target base table is executable when the above conditions are simultaneously satisfied.

For example, it is assumed that the key column included in the target base table base_tbl is the b column, and the value column is the c column.
1. If the target query statement of the materialized view of the target base table is:
create mv as select a, c+1 as c1 from base_tbl, which means that a materialized view named mv is created. The data in the materialized view is obtained by performing a query on the base_tbl table. The query selects the column a in the table and calculates c+1 to obtain a new column whose result is named c1.

According to the condition included in the first condition match item that whether the key columns of the target base table all belong to the columns referenced by the target query statement of the materialized view of the target base table, it can be seen that the key column (the b column) of the target base table does not belong to the columns of the materialized view defined by the target query statement, that is, the materialized view construction request of the target base table does not satisfy the first condition match item, and the materialized view construction request of the target base table is not executable.
2. If the target query statement of the materialized view of the target base table is:
create mv as select b, c+1 as c1 from base_tbl;
according to the condition included in the first condition match item that whether the key columns of the target base table all belong to the columns referenced by the target query statement of the materialized view of the target base table and whether the key columns of the target base table participate in calculation in the target query statement, it can be seen that the key column (the column b) of the target base table belongs to the columns referenced by the target query statement and the key column does not participate in calculation in the target query statement, then other conditions in the first condition match item may be determined.
3. If the target query statement of the materialized view of the target base table is:
create mv as select b+1 as b1 from base_tbl, which means that a materialized view named mv is created. The data source of the materialized view is a query operation on the base_tbl table, which selects a column whose result is named b1 by calculating b+1.

According to the condition included in the first condition match item that whether the key columns of the target base table all belong to the columns referenced by the target query statement of the materialized view of the target base table and whether the key columns of the target base table participate in calculation in the target query statement, it can be seen that the key column (the column b) in the target base table participates in calculation in the target query statement, that is, the materialized view construction request of the target base table does not satisfy the first condition match item, and the materialized view construction request of the target base table is not executable.
4. If the target query statement of the materialized view of the target base table is:
create mv as select b from base_tbl where c>0, which means that a materialized view named mv is created. The data in the materialized view is a value of the b column selected from the base_tbl table that satisfies the condition c>0.

According to the condition of determining whether the condition sub-statement in the target query statement references the value column of the target base table in the first condition match item, it can be seen that the where sub-statement in the target query statement of the target base table references the value column, and thus the materialized view construction request of the target base table does not satisfy the first condition match item, and the materialized view construction request of the target base table is not executable.
5. If the target query statement of the materialized view is:
create mv as select b from base_tbl where a>0, which means that a materialized view named mv is created, and the data in the materialized view is a value of the b column selected from the base_tbl table that satisfies the condition a>0.

According to the condition of determining whether the condition sub-statement in the target query statement references the value column of the target base table in the first condition match item, it can be seen that the condition sub-statement does not reference the value column, and thus the materialized view construction request of the target base table satisfies this condition, and it can be further determined whether the target query statement satisfies other conditions in the first condition match item.

In practical applications, when receiving the materialized view construction request for the target base table, after determining that the table model of the target base table belongs to the second type based on the table model of the target base table, it is further necessary to determine whether the target query statement of the materialized view of the target base table includes the aggregate operation. If it is determined that the target query statement of the materialized view of the target base table does not include the aggregate operation, whether the target query statement satisfies the third condition match item in the preset construction condition is further determined. The third condition match item is used to determine the executability of the materialized view construction request according to the type of the sub-statement of the query statement of the materialized view and whether the sub-statement to the base table references the column of the base table.

Specifically, the third condition match item may include a condition of determining whether the aggregate key columns of the materialized view in the target query statement all belong to the aggregate key columns in the target base table, a condition of determining whether the condition sub-statement in the target query statement references the value column of the target base table, and a condition of determining whether the value column of the target base table participates in calculation in the target query statement.

In practical applications, on the basis of determining that the target query statement of the materialized view of the target base table does not include the aggregate operation, whether the target base table includes the target monotonically increasing column may be first judged. If it is determined that the target base table includes the target monotonically increasing column, whether the query list sub-statement in the target query statement references the target monotonically increasing column, that is, whether the target monotonically increasing column belongs to the columns in the query list sub-statement in the target query statement, is determined. If it is determined that the query list sub-statement in the target query statement references the target monotonically increasing column, whether the target query statement satisfies the third condition match item in the preset construction condition is further determined. The query list sub-statement is used to define the columns in the materialized view.

In another optional implementation, if it is determined that the target base table does not include the target monotonically increasing column, whether the target query statement satisfies the third condition match item in the preset construction condition may be determined, so as to determine the executability of the materialized view construction request.

In practical applications, the third condition match item may also be used to determine the executability of the materialized view construction request according to a column participation calculation condition of the query statement of the materialized view. Specifically, the third condition match item further includes a condition of determining whether the value column of the target base table participates in calculation in the target query statement.

Based on the conditions included in the third condition match item, when the target query statement of the target base table does not include the aggregate operation, and the target base table does not include the target monotonically increasing column, or the target base table includes the target monotonically increasing column and the query list sub-statement of the target query statement references the target monotonically increasing column, and the aggregate key columns of the materialized view in the target query statement all belong to the aggregate key columns in the target base table, and the condition sub-statement in the target query statement does not reference the value column of the target base table, and the value column of the target base table does not participate in calculation in the target query statement, it may be determined that the materialized view construction request is executable.

In another optional implementation, when receiving the materialized view construction request for the target base table, whether the target base table belongs to the target type is judged based on the table model of the target base table. If it is determined that the target base table belongs to the second type, whether the target query statement in the materialized view construction request of the target base table includes the aggregate operation is determined. If it is determined that the target query statement of the materialized view of the target base table includes the aggregate operation, whether the target query statement satisfies the second condition match item in the preset construction condition is determined.

The second condition match item is used to determine the executability of the materialized view construction request according to at least two selected from the group consisting of the type of the sub-statement of the query statement of the materialized view, whether the sub-statement to the base table references the base table, and whether the aggregate operation satisfies a rule. The rule satisfied by the aggregate operation is a rule set for judging the aggregate operation.

Specifically, the second condition match item may include a condition of whether the aggregate key columns of the materialized view in the query statement all belong to the aggregate key columns in the target base table, a condition of whether the condition sub-statement in the query statement references the value column of the base table, a condition of whether the key columns referenced by the group sub-statement in the query statement belong to the key columns of the base table, a condition of whether the parameters of the aggregate operation in the query statement are from the value column of the base table and whether the value column does not participate in calculation in the parameters of the aggregate operation, a condition of whether the aggregate operation in the query statement satisfies the target calculation rule, and a condition of whether the aggregate operation in the query statement is consistent with the aggregate operation of the columns corresponding to the aggregate operation in the base table. The target calculation rule includes a commutative law and an associative law.

Whether the aggregate key columns of the materialized view in the target query statement all belong to the aggregate key columns in the target base table is determined, that is, whether the aggregate key columns of the materialized view are a subset of the aggregate key columns of the target base table is judged. Whether the key columns referenced by the group sub-statement in the target query statement belong to the key columns of the target base table is determined, that is, whether the key columns referenced by the group sub-statement in the target query statement of the materialized view are a subset of the key columns of the target base table is judged.

In an optional implementation, if it is determined that the aggregate key columns of the materialized view of the target query statement all belong to the aggregate key columns of the target base table, the condition sub-statement in the target query statement does not reference the value column of the target base table, the key columns referenced by the group sub-statement in the target query statement belong to the key columns of the target base table, the parameters of the aggregate operation in the target query statement are from the value column of the target base table and the value column does not participate in calculation in the parameters of the aggregate operation, the aggregate operation in the target query statement satisfies the preset calculation rule, and the aggregate operation in the target query statement is consistent with the aggregate operation of the columns corresponding to the aggregate operation in the target base table, it can be determined that the target query statement satisfies the second condition match item in the preset construction condition.

For example, it is assumed that the base table base_tbl has three columns, where columns a and b are key columns, and the column c is a value column. The base table belongs to the second type, and the aggregate function of the column c is a sum function. Taking whether the query statement of the base table satisfies the second condition match item in the preset construction condition as an example, the query statement of the materialized view is:
create mv as (select a, sum(c) s from base_tbl group by a ) aggregate key (a);
which means that a materialized view named mv is created. The data of the materialized view comes from a query on the base_tbl table. The column a is selected and the column c is summed to obtain s. Grouping is performed according to the column a, and a is specified as an aggregate key at the same time.

According to the second condition match item, it can be seen that the key columns of the materialized view defined by the query statement belong to the key columns of the base table, the key columns referenced by the group by sub-statement in the query statement belong to the key columns of the base table, the parameters of the aggregate operation in the query statement are from the value column of the base table and the value column does not participate in calculation in the parameters of the aggregate operation, the aggregate operation in the query statement satisfies the target calculation rule, and the aggregate operation in the query statement is consistent with the aggregate operation of the columns corresponding to the aggregate operation in the base table. It can be determined that the target query statement satisfies the second condition match item in the preset construction condition.

In practical applications, on the basis of determining that the target query statement of the materialized view of the target base table includes the aggregate operation, whether the target base table includes the target monotonically increasing column may be first judged. Specifically, on the basis of determining that the target query statement includes the aggregate operation, whether the target base table includes the target monotonically increasing column is determined. If it is determined that the target base table does not include the target monotonically increasing column, whether the target query statement of the materialized view of the target base table satisfies the second condition match item in the preset construction condition is determined. The target monotonically increasing column belongs to the value column of the target base table and is used to trigger an update of the target base table.

In an optional implementation, on the basis of determining that the target query statement of the materialized view of the target base table includes the aggregate operation, if the target base table does not include the target monotonically increasing column, and it is determined that the aggregate key columns of the materialized view of the target query statement all belong to the aggregate key columns of the target base table, the condition sub-statement in the target query statement does not reference the value column of the target base table, the key columns referenced by the group sub-statement in the target query statement belong to the key columns of the target base table, the parameters of the aggregate operation in the target query statement are from the value column of the target base table and the value column does not participate in calculation in the parameters of the aggregate operation, the aggregate operation in the target query statement satisfies the preset calculation rule, and the aggregate operation in the target query statement is consistent with the aggregate operation of the columns corresponding to the aggregate operation in the target base table, it can be determined that the target query statement satisfies the second condition match item in the preset construction condition.

In practical applications, when receiving the materialized view construction request for the base table, whether the materialized view construction request satisfies the preset construction condition is judged according to the table model of the target base table. If it is determined that the materialized view construction request of the target base table is not executable, that is, the materialized view construction request does not satisfy the preset construction condition, in order to help the user create the materialized view of the target base table, the embodiment of the present disclosure may further support a function of modifying the target query statement.

In an optional implementation, when determining that the materialized view construction request of the target base table is not executable, the target query statement is modified based on the preset construction condition to enable the modified target query statement to satisfy the preset construction condition. Then, the modified target query statement is displayed, and when receiving the materialized view construction request triggered for the modified target query statement, the materialized view of the target base table is constructed based on the modified target query statement.

The target query statement is modified based on the preset construction condition, specifically, the condition match item that is not satisfied by the target query statement may be determined in the preset construction condition, and whether the target query statement satisfies the preset modification condition is determined based on the condition match item. The preset modification condition is used to determine whether the target query statement can be modified based on the condition match item that is not satisfied by the target query statement, so that the target query statement satisfies the preset construction condition, that is, the materialized view construction request of the target base table is executable.

In an optional implementation, if the target query statement of the target base table satisfies the preset modification condition, the target query statement is modified based on the condition match item to enable the modified target query statement to satisfy the preset construction condition.

In another optional implementation, if the target query statement of the target base table does not conform to the preset modification condition, modification prompt information is displayed to prompt the user to manually modify the target query statement.

For example, it is assumed that the base table base_tbl has three columns, where a and b are key columns, and c is a value column.
1. Taking the base_tbl base table belonging to the first type as an example, if the query statement of the materialized view is:
create mv as select a from base_tbl where a>0;

According to the first condition match item, it can be known that the key column (the b column) of the base table does not belong to the column referenced by the above query statement, that is, the key column (the b column) of the base table does not conform to the first condition match item, which indicates that the materialized view construction request does not satisfy the preset construction condition. Then, the above query statement is modified based on the preset modification condition, and the modified query statement is as follows:
create mv as select a, b from base_tbl where a>0;
2. Taking the base table belonging to the second type as an example, the aggregate key in the base table is a. If the query statement of the materialized view is:
create mv as (select a, sum(c) s from base_tbl group by a ) aggregate key (a, s);
which means that a materialized view named mv is created. The data of the materialized view comes from a query on the base_tbl table. The a column in the base_tbl table is selected, and the c column in the base_tbl table is summed to obtain the s column. Grouping is performed according to the a column, and a and s are specified as aggregate keys at the same time.

According to the second condition match item in the preset construction condition, it can be known that the aggregate key columns of the materialized view in the query statement do not belong to the aggregate key columns of the base table, that is, the s column in the aggregate key in the query statement of the materialized view is not the aggregate key in the base table, that is, the second condition match item is not satisfied. Then, the query statement is modified, and the modified query statement is as follows:
create mv as (select a, sum(c) s from base_tbl group by a ) aggregate key (a);
3. It is assumed that the base table belongs to the second type, and the parameter in the aggregate function in the query statement of the materialized view of the base table is the key column in the base table. According to the second condition match item in the preset construction condition, it can be known that the query statement does not satisfy the preset construction condition. Since it cannot be determined, based on the preset modification condition, which value column in the base table the parameter key column in the aggregate function in the query statement should be replaced with, the query statement does not conform to the preset modification condition.

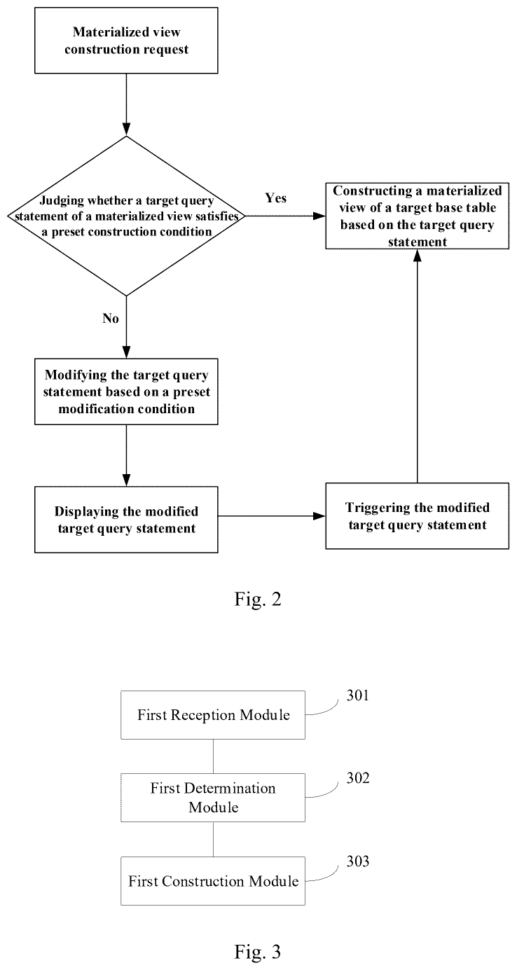

In order to facilitate the understanding of the materialized view construction method in the database system provided by the present disclosure, an embodiment of the present disclosure further provides a schematic diagram of a materialized view construction process in a database system, referring to FIG. 2.

First, when receiving the materialized view construction request for the target base table, whether the target query statement of the materialized view satisfies the preset construction condition is judged based on the target query statement carried in the materialized view construction request, the target type of the target base table, and the preset construction condition.

In an optional implementation, if it is determined that the target query statement satisfies the preset construction condition, the materialized view of the target base table is constructed based on the target query statement.

In another optional implementation, if it is determined that the target query statement does not conform to the preset construction condition, the target query statement is modified based on the preset modification condition, the modified target query statement is displayed, and when receiving the materialized view construction request triggered for the modified target query statement, the materialized view of the target base table is constructed based on the modified target query statement.

In order to implement the above embodiments, the present disclosure further provides a materialized view construction apparatus in a database system. FIG. 3 is a schematic structural diagram of a materialized view construction apparatus provided by an embodiment of the present disclosure. The apparatus may be implemented in software and/or hardware and may generally be integrated into an electronic device. As shown in FIG. 3, the apparatus includes: a first reception module 301, configured to receive a materialized view construction request for a target base table, where the materialized view construction request carries a target query statement for constructing a materialized view of the target base table; a first determination module 302, configured to determine whether the materialized view construction request satisfies a preset construction condition after determining that the target base table belongs to a target type, where the preset construction condition is used to determine the executability of the materialized view construction request according to whether a query statement of a materialized view comprises an aggregate operation and/or a sub-statement of the query statement of the materialized view references the base table, the target type includes a first type or a second type, the first type is used to identify a table with a unique constraint condition, and the second type is used to identify a table storing aggregate data; and a first construction module 303, configured to construct the materialized view of the target base table based on the target query statement when determining that the materialized view construction request is executable.

In an optional implementation, the first determination module includes: a first determination sub-module, configured to determine whether the target query statement includes an aggregate operation after determining that the target base table belongs to the first type; and a second determination sub-module, configured to determine whether the target query statement satisfies a first condition match item in the preset construction condition after determining that the target query statement does not include the aggregate operation, where the first condition match item is used to determine the executability of the materialized view construction request according to a type of the sub-statement of the query statement of the materialized view and whether the sub-statement references a column of the base table.

In an optional implementation, the first determination module includes: a third determination sub-module, configured to determine whether the target query statement includes an aggregate operation after determining that the target base table belongs to the second type; a fourth determination sub-module, configured to determine whether the target query statement satisfies a second condition match item in the preset construction condition after determining that the target query statement includes the aggregate operation, where the second condition match item is used to determine the executability of the materialized view construction request according to at least two selected from the group consisting of the type of the sub-statement of the query statement of the materialized view, whether the sub-statement references the column of the base table, and whether the aggregate operation satisfies a rule; and a fifth determination sub-module, configured to determine whether the target query statement satisfies a third condition match item in the preset construction condition after determining that the target query statement does not include the aggregate operation, where the third condition match item is used to determine the executability of the materialized view construction request according to the type of the sub-statement of the query statement of the materialized view and whether the sub-statement references the column of the base table.

In an optional implementation, the apparatus includes: a second determination module, configured to determine whether the target base table includes a target monotonically increasing column after determining that the target query statement does not include the aggregate operation, where the target monotonically increasing column belongs to a value column of the target base table and is used to trigger an update of the target base table.

Correspondingly, the second determination sub-module is further configured to: determine whether the query list sub-statement of the target query statement references the target monotonically increasing column after determining that the target base table includes the target monotonically increasing column.

In an optional implementation, the first condition match item is further used to determine the executability of the materialized view construction request according to whether a column of the query statement of the materialized view participates in calculation. The second determination sub-module includes: a sixth determination sub-module, configured to determine whether the key columns of the target base table all belong to the columns referenced by the query list sub-statement in the target query statement and determine whether the key columns of the target base table participate in calculation in the target query statement after determining that the target query statement does not include the aggregate operation; and a seventh determination sub-module, configured to determine whether the condition sub-statement in the target query statement references the value column of the target base table.

Correspondingly, the first construction module is further configured to: construct the materialized view of the target base table based on the target query statement when the following conditions are simultaneously satisfied, the conditions including: determining that the target query statement does not include the aggregate operation; the target base table does not include the target monotonically increasing column, or the target base table includes the target monotonically increasing column and the query list sub-statement of the target query statement references the target monotonically increasing column; the key columns of the target base table all belong to the columns referenced by the query list sub-statement in the target query statement and the key columns of the target base table do not participate in calculation in the target query statement; and the condition sub-statement in the target query statement does not reference the value column of the target base table.

In an optional implementation, the apparatus further includes: a third determination module, configured to determine whether the target base table includes a target monotonically increasing column after determining that the target base table belongs to the second type, where the target monotonically increasing column belongs to a value column of the target base table and is used to trigger an update of the target base table.

In an optional implementation, the fifth determination sub-module is further configured to: determine whether the query list sub-statement in the target query statement references the target monotonically increasing column after determining that the target query statement does not include the aggregate operation and the target base table includes the target monotonically increasing column.

In an optional implementation, the third condition match item is further used to determine the executability of the materialized view construction request according to whether a column of the query statement of the materialized view participates in calculation. The fifth determination sub-module includes: an eighth determination sub-module, configured to determine whether the aggregate key columns of the materialized view in the target query statement all belong to the aggregate key columns in the target base table; a ninth determination sub-module, configured to determine whether the condition sub-statement in the target query statement references the value column of the target base table; and a tenth determination sub-module, configured to determine whether the value column of the target base table participates in calculation in the target query statement.

Correspondingly, the first construction module is further configured to: construct the materialized view of the target base table based on the target query statement when the following conditions are simultaneously satisfied, the conditions including: the target query statement does not include the aggregate operation; the target base table does not include the target monotonically increasing column, or the target base table includes the target monotonically increasing column and the query list sub-statement of the target query statement references the target monotonically increasing column; the aggregate key columns of the materialized view in the target query statement all belong to the aggregate key columns in the target base table; the condition sub-statement in the target query statement does not reference the value column of the target base table; and the value column of the target base table does not participate in calculation in the target query statement.

In an optional implementation, the fourth determination sub-module is further configured to: determine whether the query list sub-statement in the target query statement references the target monotonically increasing column after determining that the target query statement includes the aggregate operation and the target base table includes the target monotonically increasing column.

In an optional implementation, the second condition match item is further used to determine the executability of the materialized view construction request according to whether a column parameter of the query statement of the materialized view participates in calculation. The fourth determination sub-module includes: an eleventh determination sub-module, configured to determine whether the aggregate key columns of the materialized view in the target query statement all belong to the aggregate key columns in the target base table; a twelfth determination sub-module, configured to determine whether the condition sub-statement in the target query statement references the value column of the target base table; a thirteenth determination sub-module, configured to determine whether the key columns referenced by the group sub-statement in the target query statement belong to the key columns of the target base table; a fourteenth determination sub-module, configured to determine whether the parameters of the aggregate operation in the target query statement are from the value column of the target base table and whether the value column does not participate in calculation in the parameters of the aggregate operation; a fifteenth determination sub-module, configured to determine whether the aggregate operation in the target query statement satisfies the target calculation rule, where the target calculation rule includes a commutative law and an associative law; and a sixteenth determination sub-module, configured to determine whether the aggregate operation in the target query statement is consistent with the aggregate operation of the columns corresponding to the aggregate operation in the target base table.

In an optional implementation, the apparatus further includes: a fourth determination module, configured to modify the target query statement based on the preset construction condition to enable the modified target query statement to satisfy the preset construction condition when determining that the materialized view construction request is not executable; a display module, configured to display the modified target query statement; and a second construction module, configured to construct the materialized view of the target base table based on the modified target query statement in response to the materialized view construction request triggered for the modified target query statement.

In an optional implementation, the apparatus further includes: a fifth determination module, configured to determine a condition match item that is not satisfied by the target query statement in the preset construction condition and determine whether the target query statement satisfies a preset modification condition based on the condition match item; and correspondingly, the second construction module is further configured to: modify the target query statement based on the condition match item to enable the modified target query statement to satisfy the preset construction condition if the target query statement satisfies the preset modification condition.

In the materialized view construction apparatus in the database system provided by the embodiments of the present disclosure, first, a materialized view construction request for a target base table is received, where the materialized view construction request carries a target query statement for constructing a materialized view of the target base table. Then, after determining that the target base table belongs to a target type, whether the materialized view construction request satisfies a preset construction condition is determined, where the preset construction condition is used to determine the executability of the materialized view construction request according to whether a query statement of a materialized view comprises an aggregate operation and/or a sub-statement of the query statement of the materialized view references the base table reference. The target type includes a first type or a second type, the first type is used to identify a table with a unique constraint condition, and the second type is used to identify a table storing aggregate data. When determining that the materialized view construction request is executable, the materialized view of the target base table is constructed based on the target query statement.

It can be seen that, in the embodiments of the present disclosure, for a base table belonging to the target type, whether the materialized view construction request for the base table satisfies the preset construction condition is determined by determining whether the query statement of the materialized view comprises the aggregate operation and whether the sub-statement of the query statement of the materialized view references the base table. When the preset construction condition is satisfied, the construction of the materialized view for the base table is supported, so as to reduce the probability that the data of the base table is inconsistent with the data in the materialized view when the data is updated.

The materialized view construction apparatus in the database system provided by the embodiments of the present disclosure can execute the materialized view construction method in the database system provided by any embodiment of the present disclosure, and has corresponding functional modules and beneficial effects for executing the method.

In order to implement the above embodiments, the present disclosure further provides a computer program product, including a computer program/instruction, which, when executed by a processor, implements the materialized view construction method in the database system in the above embodiments.

In addition to the above methods and apparatuses, an embodiment of the present disclosure further provides a computer-readable storage medium. Instructions are stored in the computer-readable storage medium, and when the instructions are run on the terminal device, the terminal device is enabled to implement the materialized view construction method in the database system according to the embodiments of the present disclosure.

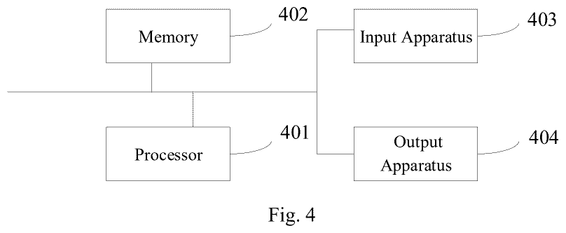

In addition, an embodiment of the present disclosure further provides a materialized view construction device in a database system, as shown in FIG. 4, which may include: a processor 401, a memory 402, an input apparatus 403, and an output apparatus 404. The number of processors 401 in the materialized view construction device in the database system may be one or more, and FIG. 4 takes one processor as an example. In some embodiments of the present disclosure, the processor 401, the memory 402, the input apparatus 403, and the output apparatus 404 may be connected through a bus or in other manners, where FIG. 4 takes connection through a bus as an example.

The memory 402 may be configured to store software programs and modules. The processor 401 executes various functional applications and data processing of the materialized view construction device in the database system by running the software programs and modules stored in the memory 402. The memory 402 may mainly include a program storage region and a data storage region, where the program storage region may store an operating system, applications required by at least one function, and the like. In addition, the memory 402 may include a high-speed random access memory and may also include a non-volatile memory, such as at least one magnetic disk storage device, a flash memory device, or other volatile solid-state storage devices. The input apparatus 403 may be configured to receive input digital or character information and generate signal input related to user settings and functional control of the materialized view construction device in the database system.

Specifically, in the present embodiment, the processor 401 loads executable files corresponding to one or more application programs into the memory 402 according to instructions described below, and the processor 401 runs the application programs stored in the memory 402, so as to implement various functions of the above materialized view construction device in the database system.

It should be noted that in this document, relational terms such as “first” and “second” are only used to distinguish one entity or operation from another entity or operation, and do not necessarily require or imply any such actual relationship or order between these entities or operations. Moreover, the terms “include/comprise” or any other variants thereof are intended to cover non-exclusive inclusion, so that a process, method, article or device including a series of elements not only includes those elements, but also includes other elements not explicitly listed, or also includes elements inherent to such process, method, article or device. Without further limitations, an element defined by the statement “include/comprise one . . . ” does not exclude that there are other same elements in the process, method, article or device including the element.

The above are only specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but will conform to the widest scope consistent with the principles and novel features disclosed herein.

1. A method for materialized view construction in a database system, comprising:
receiving a materialized view construction request for a target base table, wherein the materialized view construction request carries a target query statement for constructing a materialized view of the target base table;
determining whether the materialized view construction request satisfies a preset construction condition after determining that the target base table belongs to a target type, wherein the preset construction condition is used to determine executability of the materialized view construction request according to whether a query statement of a materialized view comprises an aggregate operation and/or a sub-statement of the query statement of the materialized view references a base table, the target type comprises a first type or a second type, the first type is used to identify a table with a unique constraint condition, and the second type is used to identify a table storing aggregate data; and
constructing the materialized view of the target base table based on the target query statement in response to determining that the materialized view construction request is executable.

2. The method according to claim 1, wherein the determining whether the materialized view construction request satisfies a preset construction condition after determining that the target base table belongs to a target type comprises:
determining whether the target query statement comprises an aggregate operation after determining that the target base table belongs to the first type; and
determining whether the target query statement satisfies a first condition match item in the preset construction condition after determining that the target query statement does not comprise the aggregate operation, wherein the first condition match item is used to determine the executability of the materialized view construction request according to a type of the sub-statement of the query statement of the materialized view and whether the sub-statement references a column of the base table.

3. The method according to claim 1, wherein the determining whether the materialized view construction request satisfies a preset construction condition after determining that the target base table belongs to a target type comprises:
determining whether the target query statement comprises an aggregate operation after determining that the target base table belongs to the second type;
determining whether the target query statement satisfies a second condition match item in the preset construction condition after determining that the target query statement comprises the aggregate operation, wherein the second condition match item is used to determine the executability of the materialized view construction request according to at least two selected from the group consisting of a type of a sub-statement of a query statement of a materialized view, whether the sub-statement references a column of the base table, and whether an aggregate operation satisfies a rule; and
determining whether the target query statement satisfies a third condition match item in the preset construction condition after determining that the target query statement does not comprise the aggregate operation, wherein the third condition match item is used to determine the executability of the materialized view construction request according to the type of the sub-statement of the query statement of the materialized view and whether the sub-statement references the column of the base table.

4. The method according to claim 2, wherein before the determining whether the target query statement satisfies the first condition match item in the preset construction condition, the determining whether the materialized view construction request satisfies a preset construction condition after determining that the target base table belongs to a target type further comprises:
determining whether the target base table comprises a target monotonically increasing column after determining that the target query statement does not comprise the aggregate operation, wherein the target monotonically increasing column belongs to a value column of the target base table and is used to trigger an update of the target base table; and
correspondingly, the determining whether the target query statement satisfies a first condition match item in the preset construction condition comprises:
determining whether a query list sub-statement of the target query statement references the target monotonically increasing column after determining that the target base table comprises the target monotonically increasing column.

5. The method according to claim 4, wherein the first condition match item is further used to determine the executability of the materialized view construction request according to whether a column of the query statement of the materialized view participates in calculation;
determining whether the target query statement satisfies a first condition match item in the preset construction condition after determining that the target query statement does not comprise the aggregate operation comprises:
determining whether key columns of the target base table all belong to columns referenced by the query list sub-statement of the target query statement and determining whether the key columns of the target base table participate in calculation in the target query statement after determining that the target query statement does not comprise the aggregate operation; and
determining whether a condition sub-statement in the target query statement references the value column of the target base table; and
correspondingly, the constructing the materialized view of the target base table based on the target query statement in response to determining that the materialized view construction request is executable comprises:
constructing the materialized view of the target base table based on the target query statement in response to following conditions are simultaneously satisfied, the following conditions comprising:
determining that the target query statement does not comprise the aggregate operation;
the target base table comprising the target monotonically increasing column, or, the target base table comprising the target monotonically increasing column and the query list sub-statement of the target query statement referencing the target monotonically increasing column;
the key columns of the target base table all belonging to the columns referenced by the query list sub-statement in the target query statement and the key columns of the target base table not participating in calculation in the target query statement; and
the condition sub-statement in the target query statement not referencing the value column of the target base table.

6. The method according to claim 3, wherein the determining whether the materialized view construction request satisfies a preset construction condition after determining that the target base table belongs to a target type further comprises:
determining whether the target base table comprises a target monotonically increasing column after determining that the target base table belongs to the second type, wherein the target monotonically increasing column belongs to a value column of the target base table and is used to trigger an update of the target base table.

7. The method according to claim 6, wherein the determining whether the target query statement satisfies a third condition match item in the preset construction condition after determining that the target query statement does not comprise the aggregate operation comprises:
determining whether a query list sub-statement in the target query statement references the target monotonically increasing column after determining that the target query statement does not comprise the aggregate operation and the target base table comprises the target monotonically increasing column.

8. The method according to claim 7, wherein the third condition match item is further used to determine the executability of the materialized view construction request according to whether a column of the query statement of the materialized view participates in calculation;
the determining whether the target query statement satisfies a third condition match item in the preset construction condition further comprises:
determining whether aggregate key columns of the materialized view in the target query statement all belong to aggregate key columns in the target base table;
determining whether the condition sub-statement in the target query statement references the value column of the target base table; and
determining whether the value column of the target base table participates in calculation in the target query statement; and
correspondingly, the constructing the materialized view of the target base table based on the target query statement in response to determining that the materialized view construction request is executable comprises:
constructing the materialized view of the target base table based on the target query statement when following conditions are simultaneously satisfied, the following conditions comprising:
the target query statement not comprising the aggregate operation;
the target base table not comprising the target monotonically increasing column, or the target base table comprising the target monotonically increasing column and the query list sub-statement of the target query statement referencing the target monotonically increasing column;
the aggregate key columns of the materialized view in the target query statement all belonging to the aggregate key columns in the target base table;
the condition sub-statement in the target query statement not referencing the value column of the target base table; and
the value column of the target base table not participating in calculation in the target query statement.

9. The method according to claim 6, wherein the determining whether the target query statement satisfies a second condition match item in the preset construction condition after determining that the target query statement comprises the aggregate operation comprises:
determining whether a query list sub-statement in the target query statement references the target monotonically increasing column after determining that the target query statement comprises the aggregate operation and the target base table comprises the target monotonically increasing column.

10. The method according to claim 9, wherein the second condition match item is further used to determine the executability of the materialized view construction request according to whether a column parameter of the query statement of the materialized view participates in calculation;
the determining whether the target query statement satisfies the second condition match item in the preset construction condition comprises:
determining whether aggregate key columns of the materialized view in the target query statement all belong to aggregate key columns in the target base table;
determining whether the condition sub-statement in the target query statement references the value column of the target base table;
determining whether key columns referenced by the group sub-statement in the target query statement belong to key columns of the target base table;
determining whether parameters of the aggregate operation in the target query statement are from the value column of the target base table and whether the value column does not participate in calculation in the parameters of the aggregate operation;
determining whether the aggregate operation in the target query statement satisfies a target calculation rule, wherein the target calculation rule comprises a commutative law and an associative law; and
determining whether the aggregate operation in the target query statement is consistent with an aggregate operation of a column corresponding to the aggregate operation in the target base table.

11. The method according to claim 1, further comprising:
modifying the target query statement based on the preset construction condition to enable the modified target query statement to satisfy the preset construction condition in response to determining that the materialized view construction request is not executable;
displaying the modified target query statement; and
constructing the materialized view of the target base table based on the modified target query statement in response to a materialized view construction request triggered for the modified target query statement.

12. The method according to claim 11, wherein before the modifying the target query statement based on the preset construction condition to enable the modified target query statement to satisfy the preset construction condition, the method further comprises:
determining a condition match item that is not satisfied by the target query statement in the preset construction condition and determining whether the target query statement satisfies a preset modification condition based on the condition match item; and
correspondingly, the modifying the target query statement based on the preset construction condition to enable the modified target query statement to satisfy the preset construction condition comprises:
modifying the target query statement based on the condition match item to enable the modified target query statement to satisfy the preset construction condition in response to the target query statement satisfying the preset modification condition.

13. An electronic device, comprising:
at least one processor; and
a memory, configured to store instructions executable by the processor,
wherein the at least one processor is configured to read the instructions from the memory and execute the instructions to implement a materialized view construction method in a database system comprising:
receiving a materialized view construction request for a target base table, wherein the materialized view construction request carries a target query statement for constructing a materialized view of the target base table;
determining whether the materialized view construction request satisfies a preset construction condition after determining that the target base table belongs to a target type, wherein the preset construction condition is used to determine executability of the materialized view construction request according to of whether a query statement of a materialized view comprises an aggregate operation and/or a sub-statement of the query statement of the materialized view references a base table, the target type comprises a first type or a second type, the first type is used to identify a table with a unique constraint condition, and the second type is used to identify a table storing aggregate data; and
constructing the materialized view of the target base table based on the target query statement in response to determining that the materialized view construction request is executable.

14. The electronic device according to claim 13, wherein the determining whether the materialized view construction request satisfies a preset construction condition after determining that the target base table belongs to a target type comprises:
determining whether the target query statement comprises an aggregate operation after determining that the target base table belongs to the first type; and
determining whether the target query statement satisfies a first condition match item in the preset construction condition after determining that the target query statement does not comprise the aggregate operation, wherein the first condition match item is used to determine the executability of the materialized view construction request according to a type of the sub-statement of the query statement of the materialized view and whether the sub-statement references a column of the base table.

15. The electronic device according to claim 13, wherein the determining whether the materialized view construction request satisfies a preset construction condition after determining that the target base table belongs to a target type comprises:
determining whether the target query statement comprises an aggregate operation after determining that the target base table belongs to the second type;
determining whether the target query statement satisfies a second condition match item in the preset construction condition after determining that the target query statement comprises the aggregate operation, wherein the second condition match item is used to determine the executability of the materialized view construction request according to at least two selected from the group consisting of a type of a sub-statement of a query statement of a materialized view, whether the sub-statement references a column of the base table, and whether an aggregate operation satisfies a rule; and
determining whether the target query statement satisfies a third condition match item in the preset construction condition after determining that the target query statement does not comprise the aggregate operation, wherein the third condition match item is used to determine the executability of the materialized view construction request according to the type of the sub-statement of the query statement of the materialized view and whether the sub-statement references the column of the base table.

16. The electronic device according to claim 14, wherein before the determining whether the target query statement satisfies the first condition match item in the preset construction condition, the determining whether the materialized view construction request satisfies a preset construction condition after determining that the target base table belongs to a target type further comprises:
determining whether the target base table comprises a target monotonically increasing column after determining that the target query statement does not comprise the aggregate operation, wherein the target monotonically increasing column belongs to a value column of the target base table and is used to trigger an update of the target base table; and
correspondingly, the determining whether the target query statement satisfies a first condition match item in the preset construction condition comprises:
determining whether a query list sub-statement of the target query statement references the target monotonically increasing column after determining that the target base table comprises the target monotonically increasing column.

17. The electronic device according to claim 16, wherein the first condition match item is further used to determine the executability of the materialized view construction request according to whether a column of the query statement of the materialized view participates in calculation;
determining whether the target query statement satisfies a first condition match item in the preset construction condition after determining that the target query statement does not comprise the aggregate operation comprises:
determining whether key columns of the target base table all belong to columns referenced by the query list sub-statement of the target query statement and determining whether the key columns of the target base table participate in calculation in the target query statement after determining that the target query statement does not comprise the aggregate operation; and
determining whether a condition sub-statement in the target query statement references the value column of the target base table; and
correspondingly, the constructing the materialized view of the target base table based on the target query statement in response to determining that the materialized view construction request is executable comprises:
constructing the materialized view of the target base table based on the target query statement in response to following conditions are simultaneously satisfied, the following conditions comprising:
determining that the target query statement does not comprise the aggregate operation;
the target base table comprising the target monotonically increasing column, or, the target base table comprising the target monotonically increasing column and the query list sub-statement of the target query statement referencing the target monotonically increasing column;
the key columns of the target base table all belonging to the columns referenced by the query list sub-statement in the target query statement and the key columns of the target base table not participating in calculation in the target query statement; and
the condition sub-statement in the target query statement not referencing the value column of the target base table.

18. The electronic device according to claim 15, wherein the determining whether the materialized view construction request satisfies a preset construction condition after determining that the target base table belongs to a target type further comprises:
determining whether the target base table comprises a target monotonically increasing column after determining that the target base table belongs to the second type, wherein the target monotonically increasing column belongs to a value column of the target base table and is used to trigger an update of the target base table.

19. The electronic device according to claim 18, wherein the determining whether the target query statement satisfies a third condition match item in the preset construction condition after determining that the target query statement does not comprise the aggregate operation comprises:
determining whether a query list sub-statement in the target query statement references the target monotonically increasing column after determining that the target query statement does not comprise the aggregate operation and the target base table comprises the target monotonically increasing column.

20. A non-transitory computer-readable storage medium, wherein the storage medium stores a computer program, and the computer program is configured to perform a materialized view construction method in a database system comprising:
receiving a materialized view construction request for a target base table, wherein the materialized view construction request carries a target query statement for constructing a materialized view of the target base table;
determining whether the materialized view construction request satisfies a preset construction condition after determining that the target base table belongs to a target type, wherein the preset construction condition is used to determine executability of the materialized view construction request according to whether a query statement of a materialized view comprises an aggregate operation and/or a sub-statement of the query statement of the materialized view references a base table, the target type comprises a first type or a second type, the first type is used to identify a table with a unique constraint condition, and the second type is used to identify a table storing aggregate data; and
constructing the materialized view of the target base table based on the target query statement in response to determining that the materialized view construction request is executable.
